(19) United States
(12) Patent Application Publication
(10) Pub. No.: US 2014/0067393 A1
(43) Pub. Date: Mar. 6, 2014

(54) MODEL LEARNING DEVICE, MODEL GENERATION METHOD, AND COMPUTER PROGRAM PRODUCT

(71) Applicant: KABUSHIKI KAISHA TOSHIBA, Tokyo (JP)

(72) Inventor: Takashi Masuko, Kanagawa (JP)

(73) Assignee: KABUSHIKI KAISHA TOSHIBA, Tokyo (JP)

(21) Appl. No.: 13/967,631

(22) Filed: Aug. 15, 2013

(30) Foreign Application Priority Data
Sep. 6, 2012 (JP) 2012-195643

(51) Int. Cl. G10L 15/06

(52) U.S. Cl. CPC G10L 15/063
USPC 704/243

(57) ABSTRACT

According to an embodiment, a model learning device learns a model having a full covariance matrix shared among a plurality of Gaussian distributions. The device includes a first calculator to calculate, from training data, frequencies of occurrence and sufficient statistics of the Gaussian distributions contained in the model; and a second calculator to select, on the basis of the frequencies of occurrence and the sufficient statistics, a sharing structure in which a covariance matrix is shared among Gaussian distributions, and calculate the full covariance matrix shared in the selected sharing structure.

### CROSS-REFERENCE TO RELATED APPLICATIONS

This application is based upon and claims the benefit of priority from Japanese Patent Application No. 2012-195643, filed on Sep. 6, 2012; the entire contents of which are incorporated herein by reference.

### FIELD

An embodiment described herein relates generally to a model learning device, a model generation method, and a computer program product.

### BACKGROUND

Gaussian distribution used for an acoustic model for speech recognition or the like has an mean vector and a covariance matrix. In general, use of a full covariance matrix taking correlation between variables into account as the covariance matrix results in higher recognition performance than using a diagonal covariance matrix that does not take correlation between variables into account. If the amount of training data for each Gaussian distribution is insufficient, however, there is a problem that a full covariance matrix often cannot be used because a full covariance matrix cannot be obtained or the reliability of the value of a full covariance matrix becomes lower.

A technique of sharing one full covariance matrix among a plurality of Gaussian distributions and learning the shared full covariance matrix by using training data of the Gaussian distributions can be considered as a technique for obtaining a full covariance matrix that is reliable even when the amount of training data for each Gaussian distribution is small. This technique allows the amount of training data per full covariance matrix to be increased as compared to the amount of training data per Gaussian distribution. In this manner, it is possible to obtain a reliable full covariance matrix by adjusting the number of full covariance matrices with respect to the amount of training data so as to improve recognition performance.

With the technique of learning a shared full covariance matrix according to the related art, however, the full covariance matrices of all the Gaussian distributions need to be obtained in advance. Furthermore, there is a problem that it is not necessarily optimum in terms of the maximum likelihood.

### BRIEF DESCRIPTION OF THE DRAWINGS

FIG. 1 is a configuration diagram illustrating an example of a configuration of a model learning device according to an embodiment;

FIG. 2 is a conceptual diagram illustrating clustering of full covariance matrices in the model learning device according to the embodiment;

FIG. 3 is a flowchart illustrating a first exemplary process performed by a second calculating unit according to the embodiment;

FIG. 4 is a flowchart illustrating a second exemplary process performed by the second calculating unit according to the embodiment; and

FIG. 5 is a conceptual diagram illustrating clustering of full covariance matrices according to a comparative example.

### DETAILED DESCRIPTION

According to an embodiment, a model learning device learns a model having a full covariance matrix shared among a plurality of Gaussian distributions. The device includes a first calculator to calculate, from training data, frequencies of occurrence and sufficient statistics of the Gaussian distributions contained in the model; and a second calculator to select, on the basis of the frequencies of occurrence and the sufficient statistics, a sharing structure in which a covariance matrix is shared among Gaussian distributions, and calculate the full covariance matrix shared in the selected sharing structure.

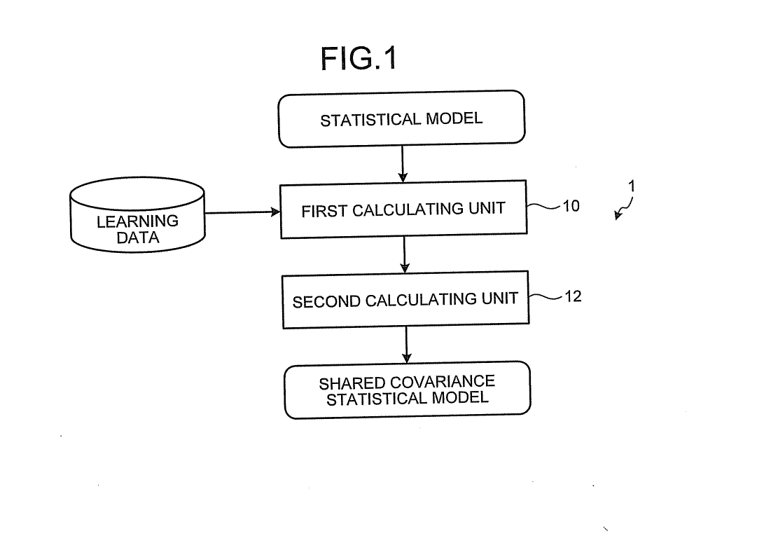

An embodiment of a model learning device will be described below in detail with reference to the accompanying drawings. Here, an example will be described in which a model having a shared full covariance matrix representing a full covariance matrix shared among a plurality of Gaussian distributions contained in a hidden Markov model used for speech recognition. FIG. 1 is a configuration diagram illustrating an example of a configuration of a model learning device 1 according to the embodiment. The model learning device 1 has functions as a computer, and includes a first calculating unit (sufficient statistic calculating unit) 10 and a second calculating unit (shared full covariance matrix calculating unit) 12 as illustrated in FIG. 1. The first calculating unit 10 and the second calculating unit 12 may be implemented by software (programs) or by hardware.

The first calculating unit 10 receives as input a hidden Markov model (statistical model) having a mixture of Gaussian distributions as output distribution, and calculates the frequency of occurrence Nₘ and the sufficient statistic Tₘ=(T₁ₘ, T₂ₘ) of a Gaussian distribution m (1≦m≦M) contained in the hidden Markov model from training data. When the training data from time 1 to time U is represented by X=(x(1), . . . , x(U)) and the occupation probability of a Gaussian distribution m at time u is represented by γₘ(u), the frequency of occurrence and the sufficient statistic can be calculated by using the following equations (1) to (3):

$$\begin{matrix}{N}_{m} = {\sum }_{u = 1}^{U} {γ}_{m} ( u ) & ( 1 ) \\ {T}_{1 m} = {\sum }_{u = 1}^{U} {γ}_{m} ( u ) x ( u ) & ( 2 ) \\ {T}_{2 m} = {\sum }_{u = 1}^{U} {γ}_{m} ( u ) x ( u ) {x ( u )}^{t} & ( 3 )\end{matrix}$$

In the equation, ·^{t} represents transposition of a matrix.

The second calculating unit 12 clusters the Gaussian distributions by using the frequencies of occurrence and the sufficient statistics calculated by the first calculating unit 10, and calculates a full covariance matrix shared among Gaussian distributions belonging to the same cluster. The second calculating unit 12 then outputs a shared covariance statistical model. Note that the second calculating unit 12 clusters the Gaussian distributions by using K-means algorithm, LBG algorithm, binary tree clustering algorithm, or the like, for example. For example, the second calculating unit 12 assumes the centroid of a cluster as the shared full covariance matrix, samples as the Gaussian distributions, and a measure of closeness (distance or similarity) between the centroid and a sample as an expected value of log likelihood (see equation (4) below). As the expected value of log likelihood is larger, the centroid and a sample are closer to each other.

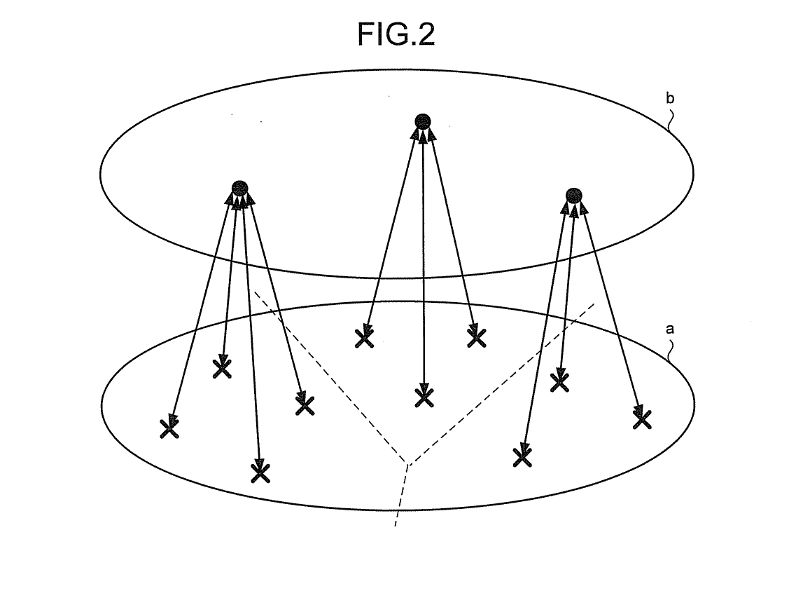

FIG. 2 is a conceptual diagram illustrating clustering of full covariance matrices (shared covariance statistical model) in the model learning device 1 according to the embodiment. In FIG. 2, an ellipse in the lower part represents a space a of sufficient statistics and an ellipse in the upper part represents a space b of full covariance matrices.

A cross mark (x) represents the sufficient statistic of each Gaussian distribution, and a black dot () represents the shared full covariance matrix that is the centroid of a cluster. In addition, a two-headed solid arrow connecting a cross mark (x) and a black dot () represents relationship between the sufficient statistic of each Gaussian distribution and the shared full covariance matrix having the maximum expected value of log likelihood calculated by using the sufficient statistic. Furthermore, a broken line represents a boundary of clusters formed in the space a of the sufficient statistics.

As illustrated in FIG. 2, the model learning device 1 clusters the full covariance matrices so that the sum of the expected values of log likelihood obtained from the sufficient statistics of the respective Gaussian distributions and the shared full covariance matrices associated therewith for all the Gaussian distributions. The model learning device 1 therefore need not obtain the full covariance matrices of the respective Gaussian distributions in advance. Furthermore, since the second calculating unit 12 performs clustering on the basis of the expected values of log likelihood, the model learning device 1 can determine (select) an optimum sharing structure in which a full covariance matrix is shared so that the sum of the expected values of log likelihood is maximized (maximum likelihood criterion).

First Exemplary Process by Second Calculating Unit 12

As a first exemplary process, the second calculating unit 12 clusters M Gaussian distributions into K (K≦M) clusters by using the K-means algorithm, and calculates a shared full covariance matrix.

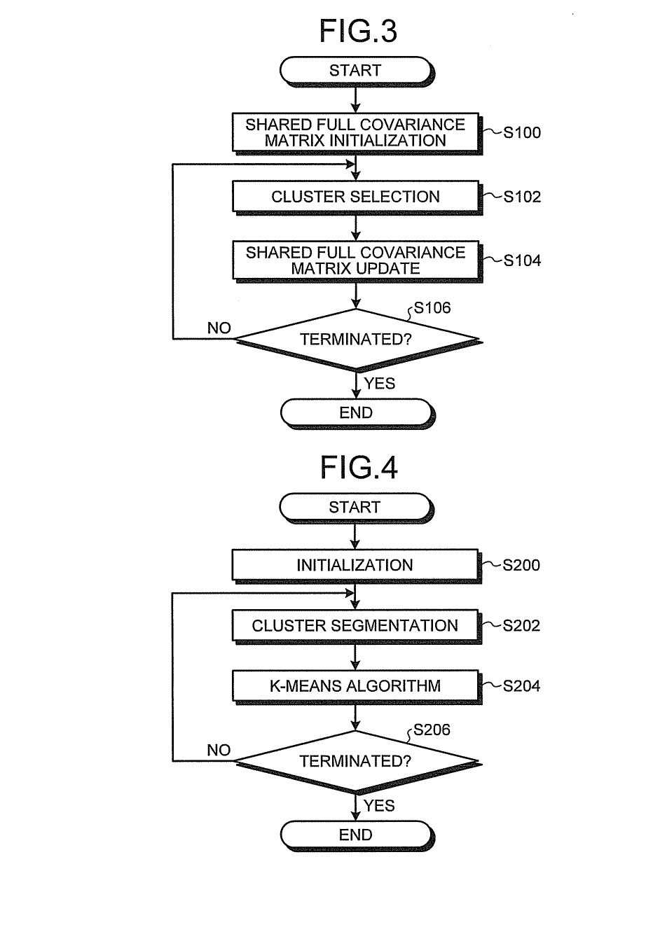

FIG. 3 is a flowchart illustrating the first exemplary process performed by the second calculating unit 12. As illustrated in FIG. 3, in a shared full covariance matrix initialization step (Step S100), the second calculating unit 12 first sets an initial shared full covariance matrix for each of K clusters. In this step, the second calculating unit 12 may select an initial shared full covariance matrix randomly from positive definite symmetric matrices. Alternatively, the second calculating unit 12 may segment M Gaussian distributions randomly into K clusters and set a shared full covariance matrix obtained by using the equation (5) below as the initial shared full covariance matrix.

In a cluster selection step (Step S102), the second calculating unit 12 selects an optimum cluster according to the maximum likelihood criterion for each Gaussian distribution. In other words, the second calculating unit 12 determines an optimum sharing structure. For example, when the shared full covariance matrix of a cluster k is represented by Σₖ, the mean vector of a Gaussian distribution m is represented by μₘ, the expected value Lₘ(k) of log likelihood for training data using the shared full covariance matrix Σₖ is calculated by the following equation (4). In the following equation (4), superscripts i and i−1 represent the number of repetitions of calculation.

$${L}_{m}^{i} ( k ) = - \frac{1}{2} [ {N}_{m} d log ( 2 π ) + {N}_{m} log \vert {\sum }_{k}^{i - 1} \vert + Tr \{ {( {\sum }_{k}^{i - 1} )}^{- 1} {T}_{2 m} \} - Tr \{ {( {\sum }_{k}^{i - 1} )}^{- 1} {T}_{1 m} {μ}_{m}^{t} \} - Tr \{ {( {\sum }_{k}^{i - 1} )}^{- 1} {μ}_{m} {T}_{1 m}^{t} \} + {N}_{m} Tr \{ {( {\sum }_{k}^{i - 1} )}^{- 1} {μ}_{m} {μ}_{m}^{t} \} ] \qquad ( 4 )$$

In the equation, d represents the number of dimensions of training data x(u) and Tr( ) represents a trace of a matrix. The expected value Lₘ(k) of log likelihood is calculated for all the clusters and a cluster for which the expected value Lₘ(k) of log likelihood is maximum is the cluster of a Gaussian distribution m.

In a shared full covariance matrix update step (Step S104), the second calculating unit 12 calculates and updates a shared full covariance matrix by the following equation (5) by using the mean vectors, the frequencies of occurrence and the sufficient statistics of the Gaussian distributions belonging to each cluster. In other words, the second calculating unit 12 updates the centroid.

$${\sum }_{k}^{i} = \frac{{\sum }_{m ∈ {C}_{k}^{i}} \{ {T}_{2 m} - {T}_{1 m} {μ}_{m}^{t} - {μ}_{m} {T}_{1 m}^{t} + {N}_{m} {μ}_{m} {μ}_{m}^{t} \}}{{\sum }_{m ∈ {C}_{k}^{i}} {N}_{m}} \qquad ( 5 )$$

In the equation, Cₖ represents a set of indices of the Gaussian distributions belonging to a cluster k.

In a termination determination step (Step S106), the second calculating unit 12 determines whether or not a termination condition of calculation of the shared full covariance matrices is satisfied. If the termination condition is not satisfied (Step S106: No), the second calculating unit 12 proceeds to the processing in Step S102. If, on the other hand, the termination condition is satisfied (Step S106: Yes), the second calculating unit 12 terminates the process. The termination condition may be “the result of the processing in the cluster selecting step (Step S102) being the same as the previous result”, “the number of repetitions of calculation having reached a predetermined number of repetitions”, or the like.

Note that the second calculating unit 12 may have software or hardware to execute the processing in each of the steps illustrated in FIG. 3. Specifically, the second calculating unit 12 may have functional blocks of software or hardware such as a shared full covariance matrix initializing unit (Step S100), a cluster selecting unit (Step S102), a shared full covariance matrix updating unit (Step S104), and a termination determining unit (Step S106).

Second Exemplary Process by Second Calculating Unit 12

As a second exemplary process, the second calculating unit 12 clusters M Gaussian distributions into K (K≦M) clusters by using the LBG algorithm (Linde-Buzo-Gray algorithm), and calculates shared full covariance matrices.

FIG. 4 is a flowchart illustrating the second exemplary process performed by the second calculating unit 12. As illustrated in FIG. 4, in an initialization step (Step S200), the second calculating unit 12 generates one cluster containing all Gaussian distributions, and calculates one shared full covariance matrix by using mean vectors, frequencies of occurrence and sufficient statistics of all the Gaussian distributions by the aforementioned equation (5). The second calculating unit 12 then sets the number K′ of clusters to 1.

In a cluster segmentation step (Step S202), the second calculating unit 12 increases the number of clusters from K′ to min(K, nK′) (cluster segmentation). Note that n is within a range of 1<n≦2, and n=2 is typically used. In addition, min(a, b) is a function that outputs the smaller of a and b.

More specifically, the second calculating unit 12 selects min(K, nK′)−K′ shared full covariance matrices from K′ shared full covariance matrices and segments each shared full covariance matrix into two. Subsequently, the second calculating unit 12 combines 2(min(K, nK′)−K′) shared full covariance matrices obtained by the segmentation and K′−(min(K, nK′)−K′) full covariance matrices that are not segmented to obtain min(K, nK′) shared full covariance matrices. The second calculating unit 12 then updates the number K′ of clusters to min(K, nK′).

In a K-means algorithm step (Step S204), the second calculating unit 12 executes the K-means algorithm using K′ shared full covariance matrices obtained in the cluster segmentation step (Step S202) as the initial shared full covariance matrices to calculate K′ shared full covariance matrices.

In a termination determination step (Step S206), the second calculating unit 12 determines whether or not the number of clusters is a desired number K. If K′<K (Step S206: No), the second calculating unit 12 proceeds to the processing in Step S202. If K′=K (Step S206: Yes), on the other hand, the second calculating unit 12 terminates the process.

Note that the second calculating unit 12 may have software or hardware to execute the processing in each of the steps illustrated in FIG. 4. Specifically, the second calculating unit 12 may have functional blocks of software or hardware such as an initializing unit (Step S200), a cluster segmentation unit (Step S202), a K-means algorithm unit (Step S204), and a termination determining unit (Step S206).

Furthermore, the first calculating unit 10 may be configured to obtain an amount expressed by the following equation (6) instead of the sufficient statistic Tₘ=(T₁ₘ, T₂ₘ)

$${D}_{m} = {\sum }_{u = 1}^{U} {γ}_{m} ( u ) ( {x}_{u} - {μ}_{m} ) {( {x}_{u} - {μ}_{m} )}^{t} \qquad ( 6 )$$

In this case, the aforementioned equations (4) and (5) are expressed by the following equations (7) and (8), respectively.

$$\begin{matrix}{L}_{m} ( k ) = - \frac{1}{2} \{ {N}_{m} d log ( 2 π ) + {N}_{m} log \vert {Σ}_{k} \vert + Tr ( {\sum }_{k}^{- 1} {D}_{m} ) \} & ( 7 ) \\ {Σ}_{k} = \frac{{\sum }_{m ∈ {C}_{k}^{i}} {D}_{m}}{{\sum }_{m ∈ {C}_{k}^{i}} {N}_{m}} & ( 8 )\end{matrix}$$

The model learning device 1 according to the embodiment includes a control device such as a CPU, a storage device such as a ROM and a RAM, an external storage device such as an HDD and a CD drive, a display device such as a display, and an input device such as a keyboard and a mouse, which is a hardware configuration utilizing a common computer system.

Model generation programs to be executed by the model learning device 1 according to the embodiment are recorded on a computer readable recording medium such as a CD-ROM, a flexible disk (FD), a CD-R, and a DVD (digital versatile disk) in a form of a file that can be installed or executed, and provided therefrom.

Alternatively, the model generation programs to be executed by the model learning device 1 according to the embodiment may be stored on a computer system connected to a network such as the Internet, and provided by being downloaded via the network. Still alternatively, the model generation programs to be executed by the model learning device 1 according to the embodiment may be provided or distributed through a network such as the Internet.

Still alternatively, the model generation programs according to the embodiment may be embedded on a ROM or the like in advance and provided therefrom.

The model generation programs to be executed by the model learning device 1 according to the embodiment have a modular structure including the respective units (the first calculating unit 10 and the second calculating unit 12) described above, for example. In an actual hardware configuration, a CPU (processor) reads the model generation programs from the storage medium mentioned above and executes the programs, whereby the first calculated unit 10 and the second generating units are loaded on a main storage device and generated thereon.

As described above, according to the model learning device 1 according to the embodiment, pattern recognition performance can be improved even when the full covariance matrices of all the Gaussian distributions cannot be obtained in advance. Specifically, the model learning device 1 can determine an optimum sharing structure in which a full covariance matrix is shared on the basis of the maximum likelihood criterion even when a full covariance matrix cannot be obtained owing to lack of training data for each Gaussian distribution.

Comparative Example of Clustering Full Covariance Matrices

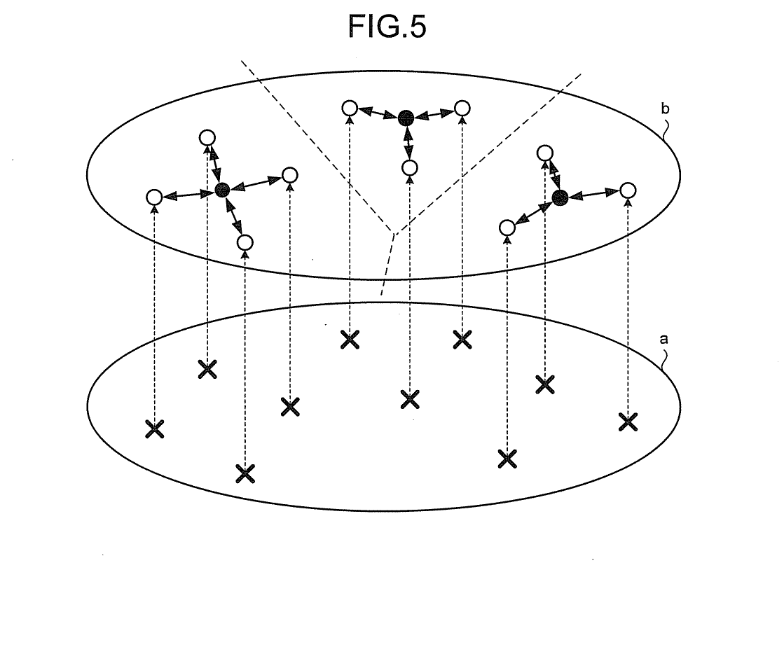

FIG. 5 is a conceptual diagram illustrating clustering of full covariance matrices according to a comparative example. In FIG. 5, similarly to FIG. 2, an ellipse in the lower part represents a space a of sufficient statistics and an ellipse in the upper part represents a space b of full covariance matrices.

A cross mark (x) represents the sufficient statistic of each Gaussian distribution, a white dot (o) represents the full covariance matrix of each Gaussian distribution, and a black dot () represents the shared full covariance matrix that is the centroid of a cluster. A single-headed dashed arrow from a cross mark (x) toward a white dot (o) means that a full covariance matrix is to be obtained from the sufficient statistic for each Gaussian distribution. In addition, a two-headed solid arrow connecting a white dot (o) and a black dot () represents relationship between the full covariance matrix of each Gaussian distribution and the shared full covariance matrix at the shortest distance therefrom.

Furthermore, a broken line represents a boundary of clusters formed in the space b of the full covariance matrices. In the clustering of the full covariance matrices according to the comparative example, clustering is performed on the basis of the sum of distances between the full covariance matrices of the respective Gaussian distributions and the shared full covariance matrices associated therewith so that the sum becomes the smallest. Accordingly, it is necessary to obtain the full covariance matrix from the sufficient statistic for each Gaussian distribution in advance. Furthermore, since the clustering of the full covariance matrices according to the comparative example is based on the distances between the full covariance matrices, it is not necessarily optimum in terms of the maximum likelihood.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A model learning device for learning a model having a full covariance matrix shared among a plurality of Gaussian distributions, the device comprising:
a first calculator configured to calculate, from training data, frequencies of occurrence and sufficient statistics of the Gaussian distributions contained in the model; and
a second calculator configured to select, on the basis of the frequencies of occurrence and the sufficient statistics, a sharing structure in which a covariance matrix is shared among Gaussian distributions, and calculate the full covariance matrix shared in the selected sharing structure.

2. The device according to claim 1, wherein the second calculator selects the sharing structure on the basis of an expected value of log likelihood calculated by using the frequencies of occurrence and the sufficient statistics.

3. The device according to claim 1, wherein the second calculator includes:
a cluster selector configured to select a cluster with maximum likelihood for each of the Gaussian distributions; and
a shared full covariance matrix updating unit configured to update the shared full covariance matrix on the basis of mean vectors, the frequencies of occurrence and the sufficient statistics of the Gaussian distributions belonging to the cluster.

4. The device according to claim 1, wherein the second calculator calculates the shared full covariance matrix by an LBG algorithm using the frequencies of occurrence and the sufficient statistics repeatedly for calculation.

5. The device according to claim 1, wherein the model is a hidden Markov model that outputs a mixture of Gaussian distributions.

6. A model generation method for generating a model having a full covariance matrix shared among a plurality of Gaussian distributions, the method comprising:
calculating, from training data, frequencies of occurrence and sufficient statistics of the Gaussian distributions contained in the model;
selecting, on the basis of the frequencies of occurrence and the sufficient statistics, a sharing structure in which a covariance matrix is shared among Gaussian distributions; and
calculating the full covariance matrix shared in the selected sharing structure.

7. A computer program product comprising a computer-readable medium containing a model generation program for generating a model having a full covariance matrix shared among a plurality of Gaussian distributions, the program causing a computer to execute:
calculating, from training data, frequencies of occurrence and sufficient statistics of the Gaussian distributions contained in the model;
selecting, on the basis of the frequencies of occurrence and the sufficient statistics, a sharing structure in which a covariance matrix is shared among Gaussian distributions; and
calculating the full covariance matrix shared in the selected sharing structure.
